(19) United States
(12) Patent Application Publication
(10) Pub. No.: US 2006/0277486 A1
(43) Pub. Date: Dec. 7, 2006

(54) File or user interface element marking system

(76) Inventor: David N. Skinner, Redwood Shores, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/143,222

(22) Filed: Jun. 2, 2005

(51) Int. Cl. G06F 9/00

(52) U.S. Cl. 715/772

(57) ABSTRACT

A file marking system for marking a computer file so that it is visually distinguishable from other computer files. The system includes a selecting sub-system for allowing a user to determine how the computer file is marked based on predetermined criteria. The system also includes a marking sub-system for marking the file based on the predetermined criteria so that it is visually distinguishable from the other files.

### BACKGROUND OF THE INVENTION

1. Field of the Invention

This invention relates generally to an interface element or computer file marking system and, more particularly, to an interface element or computer file marking system that marks or stains a computer file or other interface element by visually identifying the file based on how frequently the file is used, how infrequently the file is used or other factors.

2. Discussion of the Related Art

For certain computer user interfaces, such as the Windows operating system, it is typically difficult to readily distinguish the various files or user interface elements from each other when displayed on the computer monitor because the files typically visually look alike, even though they are named differently. For example, when a file folder is opened in Windows that includes many files, the user typically has to read several of the files to determine which file the user wishes to select. Therefore, it sometimes is frustrating for the user because the desired file may not be able to be quickly found.

One solution to this problem in Windows and other operating systems is to provide a shortcut on the computer desktop for a particular file that is used often. However, such a solution may eventually revert to the original problem because there may be several icons on the desktop that look alike, where the user would still not know which file is desired to be opened without reading several of the files. Additionally, files can be named so that they are sorted in the file folder differently, for example, where the most used files are first in the list. However, this is not always convenient or possible. Further, user interface elements can be colored differently so that they are distinguishable from each other. However, coloring the files differently does not indicate their frequency of use.

### SUMMARY OF THE INVENTION

In accordance with the teachings of the present invention, a system is disclosed for visually identifying a user interface element or computer file when it is displayed on a computer monitor with other files, such as in a file folder. The user can select or optimize how the system identifies the file using a system menu. The identifying selection criteria could include the color of the identification, the file size, the type of mark used for identifying, the length of time the identification remains on the file, etc. Therefore, the most used files, or other identified files, are readily identifiable relative to other files.

Additional features of the present invention will become apparent from the following description and appended claims, taken in conjunction with the accompanying drawings.

### BRIEF DESCRIPTION OF THE DRAWINGS

FIG. 1 is a diagram of an opened file folder displayed on a computer monitor in a Windows operating system, where files in the file folder have been highlighted by a certain color and where the intensity of the highlighting identifies the frequency of use of the file, according to an embodiment of the present invention;

FIG. 2 is an optimization menu for selecting how files are marked for the file marking system of the invention;

FIG. 3 is a depiction of a column of user interface menu items for a computer operating system where a highlighted border for a menu item indicates frequency of use of the item; and

FIG. 4 is a matrix of photo thumbnails in a file folder where certain of the thumbnails have been marked by a highlighted border to show which photos have been selected the most often.

### DETAILED DESCRIPTION OF THE EMBODIMENTS

The following discussion of the embodiments of the invention directed to a system for visually identifying or marking files in a computer operating system is merely exemplary in nature, and is in no way intended to limit the invention or its applications or uses.

The present invention proposes a file marking system for quickly identifying files displayed on a computer monitor based on predetermined criteria by making the files more visually identifiable than other displayed files. For example, the file marking system marks or stains a particular file, such as by highlighting, where the intensity of the mark or stain causes the user to readily recognize which files are more frequently used or which files satisfy some other criteria. Each time the user “clicks” on the file, the system would then update the highlighting of that file. The file marking system would include built in intelligence employing software code to recognize files and functions that the user has identified as being important for easy identification, and thus quick access through the user defined criteria. One of skill in the art would be able to provide the software code necessary to provide the marking system of the invention. The system would include a screen or window that allows the user to select the desired criteria. Various criteria include selecting the frequency of use of the file, the file size, type of mark or stain used, length of time the mark remains, etc.

Additionally, a highlighted file may fade or change over time as the file becomes infrequently used. Also, a file that has not been used for a certain period of time may also be highlighted differently than a frequently used file, such as by a red line, so that the user readily knows which files have not been used for awhile to possibly delete the files.

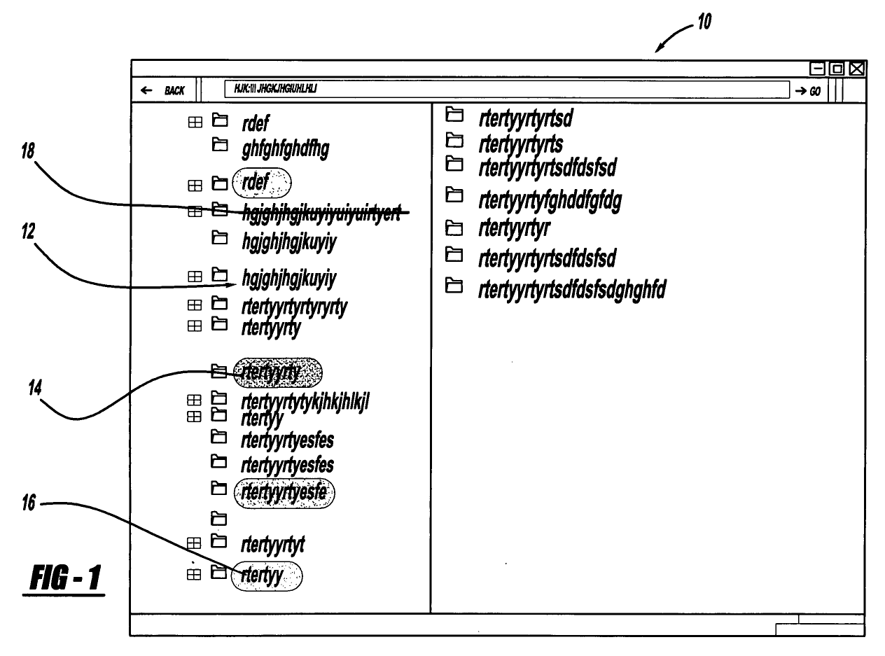

FIG. 1 is an illustration of an opened file folder 10 in the Windows operating system including a plurality of listed files 12 displayed on a computer monitor. As is apparent, certain of the files, such as files 14 and 16, have been highlighted with a predetermined color by the file marking system of the invention so that they are distinguishable from the other files. In this embodiment, the intensity of the highlighting is different for the highlighted files 14 and 16. In one example, the intensity of the highlighting is dependent on the frequency of use of the file 12. In this non-limiting example, the file 14 is used more often than the file 16 because the highlighting of the file 14 is darker. Therefore, the user will be able to readily recognize the files 12 that are more frequently used. The system may allow the highlighted file 14, 16 to fade overtime, depending on user selected criteria, so that previously frequently used files, but now infrequently used files, are not as readily identifiable. Also, in this example, a file 18 has a line through it, where the marking system has indicated that the file 18 has not been opened for a predetermined period of time.

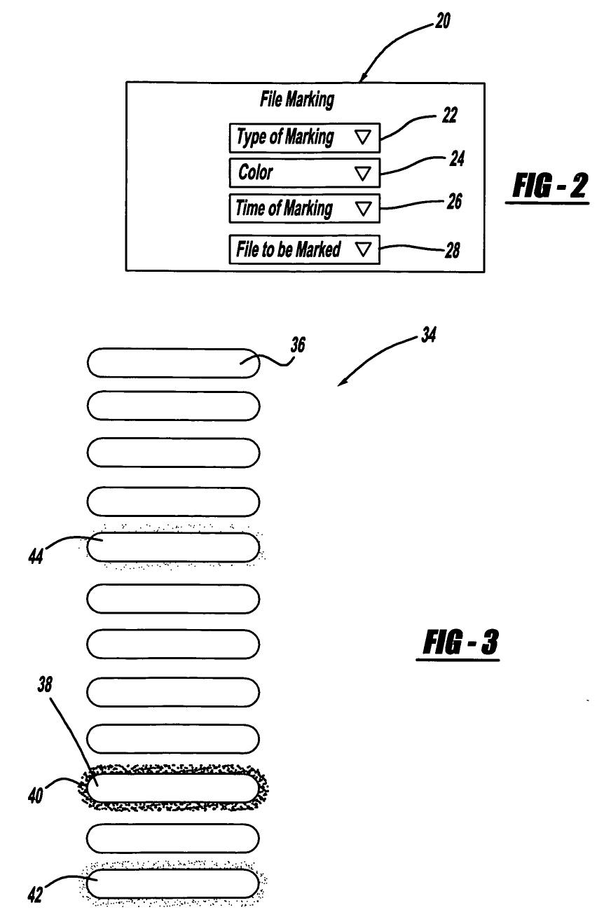

FIG. 2 is a Windows dialog box 20 displayed on a computer monitor that allows the user to select how, when and for how long the files are marked, consistent with the discussion herein. In this non-limiting example, the dialog box 20 includes selections provided by the user including the type of marking, the color of the marking, the length of time of the marking and the files to be marked. Particularly, the dialogue box 20 includes a pull down menu 22 for the type of marking. For example, the user can select from the pull down menu 22 various marking techniques, such as highlighting the entire file, highlighting the border of the file, putting a checkmark next to the file, ordering the file in a predetermined manner, striking out a file that has been infrequently used, etc. The dialogue box 20 also includes a color pull down menu 24 where the user can select the color of the highlighting, such as red, yellow, etc., in combination with the type of marking from the pull down menu 22. The dialogue box 20 also includes a time of marking pull down menu 26 that allows the user to select when the file will be marked or stained. For example, the intensity of the highlighting can be increased if the user opens the file every predetermined period of time, such as one day, one week, etc. The dialogue box 20 also includes a file to be marked pull down menu 28 that allows the user to select which type of files, or which specific files, will be highlighted or identified. For example, the user may select to only highlight text files, photo files, files on the desktop, or any combination thereof, etc. It is also within the scope of the present invention that the user be able to select other criteria not specifically discussed herein.

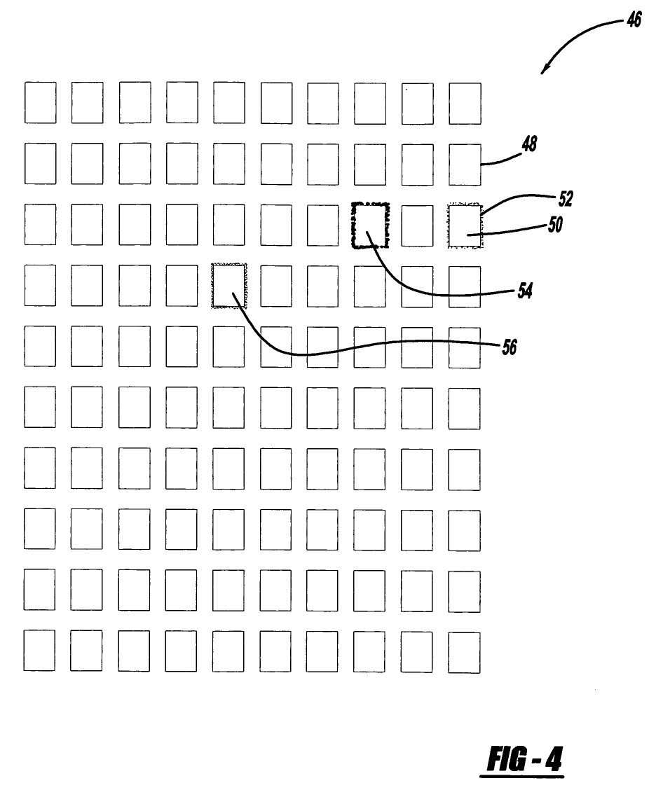

FIG. 3 is a column 34 of user interface menu items 36 for a computer operating system where some of the menu items 36 have a highlighted or stained border. The column 34 is intended to be a general representation of a user interface for a computer operating system, and the menu items 36 are intended to represent any computer file or element. In this example, a menu item 38 has a dark stained border 40, a menu item 42 has a medium stained border and a menu item 44 has a light stained border. The darker the stained border for a particular menu item 36 the more often that menu item 36 has been selected or opened, and the more readily the user will be able to identify the item 36.

FIG. 4 is a matrix 46 of photo thumbnails 48 or photo files representing an array of selectable photos in a file folder. The system of identifying the files of the invention in this example has marked the photo thumbnails 48 with an outer highlighted border showing the frequency of how often the photo file has been opened, where the darker the highlighted border the more often the photograph has been opened. In this example, a photo thumbnail 50 has a medium stained border 52, a photo thumbnail 54 has a dark stained border and a photo thumbnail 56 has a light stained border. Therefore, the user can readily identify those photos that have been opened the most often.

The foregoing discussion discloses and describes merely exemplary embodiments of the present invention. One skilled in the art will readily recognize from such discussion, and from the accompanying drawings and claims, that various changes, modifications or variations can be made therein without departing from the spirit and scope of the invention as defined in the following claims.

What is claimed is:

1. A file marking system for marking a computer file so that it is visually distinguishable from other computer files, said system comprising:
a selecting sub-system for allowing a user to determine how the computer file is marked based on predetermined criteria; and
a marking sub-system for marking the file based on the predetermined criteria so that it is visually distinguishable from the other files.

2. The system according to claim 1 wherein the predetermined criteria includes the frequency of use of the file.

3. The system according to claim 1 wherein the predetermined criteria includes how long the file has been marked.

4. The system according to claim 1 wherein the predetermined criteria includes the infrequency of use of the file.

5. The system according to claim 1 wherein the marking sub-system highlights the file With a predetermined color having a varying intensity depending on the predetermined criteria.

6. The system according to claim 5 wherein the highlighting of the file increases in intensity the more the file is used and decreases in intensity the less the file is used.

7. The system according to claim 1 wherein the marking sub-system provides a highlighted border around the file.

8. The system according to claim 1 wherein the marking sub-system updates the marking of the file each time the file is opened.

9. The system according to claim 1 wherein the file is a photo file.

10. A file marking system for marking a computer file so that it is visually distinguishable from other computer files, said system comprising:
a selecting sub-system for allowing a user to determine how the computer file is marked based on predetermined criteria, wherein the predetermined criteria includes frequency of use of the file, infrequency of use of the file and how long the file has been marked; and
a marking sub-system for marking the file so that it is visually distinguishable from the other files based on the predetermined criteria, said marking sub-system highlighting the file with a predetermined color having a varying intensity.

11. The system according to claim 10 wherein highlighting the file includes changing the intensity of the highlighting based on how often the file is used.

12. The system according to claim 10 wherein the marking sub-system provides a highlighted border around the file.

13. The system according to claim 10 wherein the marking sub-system updates the marking of the file each time the file is opened.

14. A method for marking a computer file so that it is visually distinguishable from other computer files, said method comprising:
determining how the file is marked based on predetermined criteria; and
marking the file based on the predetermined criteria so that it is visually distinguishable from the other files.

15. The method according to claim 14 wherein determining how the file is marked includes using frequency of use of the file.

16. The method according to claim 14 wherein determining how the file is marked includes using infrequency of use of the file.

17. The method according to claim 15 wherein determining how the file is marked includes determining how long the file has been marked.

18. The method according to claim 15 wherein marking the file includes highlighting the file with a predetermined color having a varying intensity.

19. The method according to claim 15 wherein marking the file includes providing a highlighted border around the file.

20. The method according to claim 15 wherein marking the file includes updating the marking of the file each time the file is opened.
